(19) United States
(12) Patent Application Publication
(10) Pub. No.: US 2012/0137123 A1
(43) Pub. Date: May 31, 2012

(54) ENCRYPTION/DECRYPTION COMMUNICATION SYSTEM

(75) Inventor: Guangming Yang, Shenyang (CN)

(73) Assignee: NORTHEASTERN UNIVERSITY TECHNOLOGY TRANSFER CENTER, Shenyang, Liaoning (CN)

(21) Appl. No.: 13/318,586

(22) PCT Filed: Aug. 5, 2010
(86) PCT No.: PCT/CN10/75738

§ 371 Date: Nov. 2, 2011

(51) Int. Cl. H04L 9/00

(52) U.S. Cl. 713/150

(57) ABSTRACT

The present disclosure relates to an encryption/decryption device and method and a communication system including the encryption/decryption device. The device includes a receiving part; an address analyzing part; a judging part; an encrypting/decrypting part and a sending part. The judging part is adapted to judge whether an encryption/decryption process needs to be performed in accordance with the source address and/or the destination address of the data package. Thus, a safe network transmission of the user data is achieved without the need of installing and configuring software and the user is easy to realize the security of data transmission.

### FIELD OF THE INVENTION

The present invention relates to the field of information security, and more particularly, to an encryption/decryption device and method, and a communication system including the encryption/decryption device.

### BACKGROUND OF THE INVENTION

With the rapid development of network, more and more data is being transmitted via the network, and accordingly network information theft has increased rapidly.

The traditional way to prevent the information theft is to install and configure an auxiliary software on a computer manually. The installed software performs information protection for the computer. Particularly, when a user intends to send a data package or receive a data package, the user needs to install and configure the auxiliary software manually and send or receive the data package via the auxiliary software.

### SUMMARY OF THE INVENTION

Some embodiments of the present disclosure provide an encryption/decryption device and method, and a communication system including the encryption/decryption device, so as to facilitate safe network transmission of the user data without the need of installing and configuring the auxiliary software manually.

An embodiment of the present disclosure provides an encryption/decryption device. The encryption/decryption device may include a receiving part, an address analyzing part, a judging part, an encrypting/decrypting part and a sending part. The receiving part may be adapted to receive a data package from an information device or a network. The address analyzing part may be adapted to analyze a source address and/or a destination address of the data package. The judging part may be adapted to judge whether an encryption/decryption process needs to be performed in accordance with the source address and/or the destination address of the data package. The encrypting/decrypting part may be adapted to encrypt or decrypt the data package in the case that the encryption or decryption process is required. The sending part may be adapted to send an encrypted or decrypted data package to the information device or the network.

Another embodiment of the present disclosure provides an encryption/decryption method. The encryption/decryption method may include: receiving a data package from an information device or a network; analyzing a source address and/or a destination address of the data package; judging whether an encryption/decryption process needs to be performed in accordance with the source address and/or the destination address of the data package; encrypting/decrypting the data package in the case that it is determined that the encryption/decryption process needs to be performed; and sending the data package without encryption/decryption in the case that the encryption/decryption process is not necessary.

Another embodiment of the present disclosure provides a communication system. The communication system may include at least one information device and at least one encryption/decryption device connected with the at least one information device respectively. The at least one encryption/decryption device may be the encryption/decryption device as stated above.

Another embodiment of the disclosure provides a program product including machine-executable instructions which, when executed by an information processing device, causes the information processing device to perform the method described above.

Another embodiment of the disclosure provides a storage medium, including a machine executable program code, when the program code is executed in an information processing device, the program code makes the information processing device to execute the method as described above.

The foregoing is a summary and thus contains, by necessity, simplifications, generalization, and omissions of detail(s). Consequently, those skilled in the art will appreciate that the summary is illustrative only and is not intended to be in any way limiting. Other aspects, features, and advantages of the apparatus and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the present disclosure and are, therefore, not to be considered limiting of its scope, the present disclosure will be described with additional specificity and detail through use of the accompanying drawings.

FIG. 1 is a schematic diagram illustrating an encryption device according to an embodiment of the disclosure;

FIG. 2 is a schematic diagram illustrating a decryption device according to another embodiment of the disclosure;

FIG. 3 is a schematic diagram illustrating an encryption/decryption device according to another embodiment of the disclosure;

FIG. 4 is a schematic diagram illustrating an encryption/decryption device according to another embodiment of the disclosure;

FIG. 5 is a schematic diagram illustrating an encryption/decryption device according to another embodiment of the disclosure;

FIG. 6 is a schematic diagram illustrating an encryption/decryption device according to another embodiment of the disclosure;

FIG. 7 is a schematic diagram illustrating a communication system according to an embodiment of the disclosure;

FIG. 8 is a schematic diagram illustrating an encryption method according to an embodiment of the disclosure;

FIG. 9 is a schematic diagram illustrating a decryption method according to an embodiment of the disclosure; and

FIG. 10 is a schematic diagram illustrating an encryption/decryption method according to an embodiment of the disclosure.

### DETAILED DESCRIPTION OF THE EMBODIMENTS

In the following detailed description, reference is made to the accompanying drawings, which form a part hereof. In the drawings, similar symbols typically identify similar components, unless the context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to devices, systems, methods, program products and medium related to security of data transmission.

FIG. 1 is a schematic diagram illustrating an encryption device according to an embodiment of the disclosure.

As shown in FIG. 1, an encryption device 100 according to an embodiment of the disclosure may include a receiving part 102, an address analyzing part 104, a judging part 106, an encrypting 108 and a sending part 110.

The receiving part 102 may be adapted to receive a data package to be sent to a network from an information device in a wired or wireless manner.

As an example, in the case that the receiving part 102 receives data package from the information device in a wired manner, the receiving part 102 may be a wired data-receiving device such as a network card or a USB device, or any other wired communication port. Thus, the receiving part 102 may be coupled with the information device in a wired manner.

As another example, in the case that the receiving part 102 receives data package from the information device in a wireless manner, the receiving part 102 may be a wireless data-receiving device such as a wireless network card and Bluetooth device, or any other wireless communication port. Thus, the receiving part 102 may be coupled with the information device in a wireless manner.

The network may be any suitable data-transmission network such as mobile telephone network, Local Area Network (LAN), Metropolitan Area Network (MAN) and the Internet.

The information device may be any suitable device which is adapted to receive and send data, such as computer, cell phone and media player.

The data package may be various kind of data package such as content data package, multi-media data package, stream media data package and Internet Protocol (IP) data package.

Referring to FIG. 1, the address analyzing part 104 may be adapted to analyze a destination address of the data package received by the receiving part 102.

Particularly, the address analyzing part 104 may be adapted to resolve the data package and obtain a destination address of the data package.

Moreover, the address obtained by the address analyzing part 104 may take any suitable form.

As an example, when the data package is an IP data package, the address obtained by the address analyzing part 104 may be the IP address of the data package.

As another example, when the data package is multi-media data package or stream media data package, the address may be the name of the sever storing the multi-media data package or stream media data package.

Referring to FIG. 1, a judging part 106 may be adapted to judge whether an encryption process needs to be performed to the data package, in accordance with the destination address of the data package obtained by the address analyzing part 104.

In the case that the judging part 106 determines that the encryption process needs to be performed, the judging part 106 may transfer the data package to an encrypting 108 for encryption.

The encrypting part 108 may employ any suitable encryption technology to implement the encryption of the data package and transfer an encrypted data package to a sending part 110.

On the other hand, in the case that the judging part 106 determines that the encryption process does not need to be performed, the judging part 106 may inform the information device to send the data package without encryption.

As shown in FIG. 1, the sending part 110 may be adapted to send an encrypted data package to the network.

Similar to the receiving part 102, the sending part 110 may send the encrypted data package to the network in a wired or wireless manner.

As an example, the sending part 110 may be a wireless data-sending device such as a wireless network card and Bluetooth device, or any other wireless communication port. As another example, the sending part 110 may be a wired data-sending device such as a network card or a USB device, or any other wired communication port.

As can be seen from FIG. 1, when the judging part 106 determines that the encryption process does not need to be performed, the judging part 106 may inform the information device to send the data package directly without encryption. However, FIG. 1 is merely an example and can not construct any limitation and the encryption device 100 may also be implemented in other configuration.

In another embodiment of the disclosure, the judging part may also inform the sending part to send the data package without encryption to network, in the case that the judging part determines that the encryption does not need to be performed.

Moreover, the encryption 100 may be configured in the information device or outside the information device.

As an example, the encryption device 100 may be configured outside the information device. When the encryption device 100 is configured outside the information device, the encryption device 100 may be connected with the information device in a wired manner or a wireless manner via the receiving part 102.

As another example, the encryption device 100 may be integrated in the information device in a manner of hardware. For example, the encryption device 100 may be mounted in the information device via a slot and the encryption device 100 may function as an internal hardware of the information device.

Alternatively, the encryption device 100 may be integrated in the information device in a manner of software and the software is provided in the information device via a storing device such as ROM (Read Only Memory) and portable storing device.

With the above encryption device 100, a safe network transmission of the user data is achieved without the need of manually installing and configuring software.

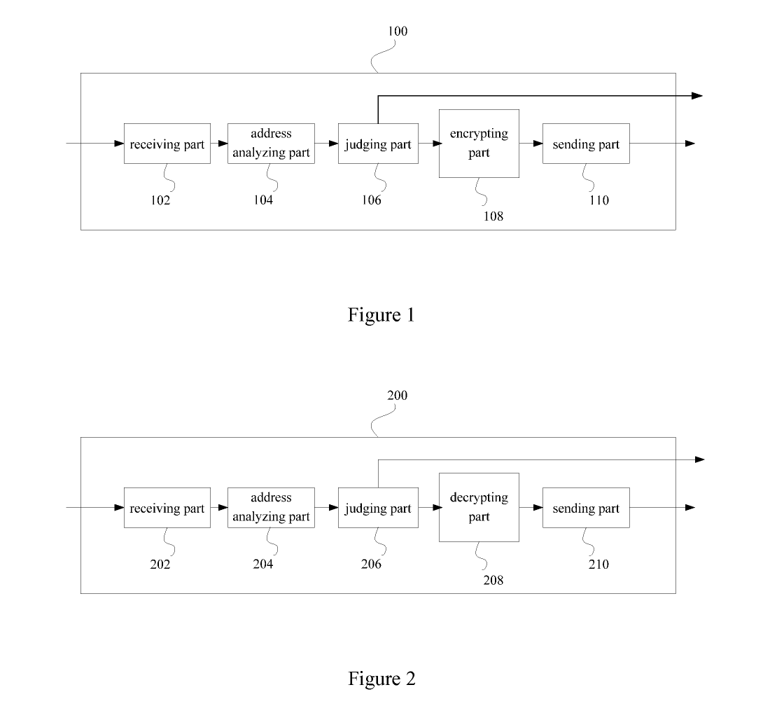

FIG. 2 is a schematic diagram illustrating a decryption device according to an embodiment of the disclosure.

As shown in FIG. 2, a decryption device 200 according to an embodiment of the disclosure may include a receiving part 202, an address analyzing part 204, a judging part 206, a decrypting part 208 and a sending part 210.

The receiving part 202 may be adapted to receive a data package from a network in a wired or wireless manner.

The address analyzing part 204 may be adapted to analyze a source address of the data package received by the receiving part 202.

The judging part 206 may be adapted to judge whether a decryption process needs to be performed to the data package, in accordance with the source address of the data package obtained by the address analyzing part 204.

In the case that the judging part 206 determines that the decryption process needs to be performed, the judging part 206 may transfer the data package to a decryption 208 for decryption.

The decrypting part 208 may employ any suitable decryption technology to implement the decryption of the data package and transfer a decrypted data package to a sending part 210.

In the case that the judging part 206 determines that the decryption process does not need to be performed, the judging part 206 may inform the information device to receive the data package without decryption directly from the network.

The sending part 210 may send the decrypted data package to the information device in a wired or wireless manner.

Moreover, the detail structure and configuration of the receiving part 202, the address analyzing part 204, the judging part 206 and the sending part 210 may be similar to the receiving part 102, the address analyzing part 104, the judging part 106 and the sending part 110 as stated above. Thus, detailed descriptions thereof are omitted herein.

Furthermore, the relationship between the decryption device 200 and the information device may be similar to that between the encryption device 100 and the information device and thus detailed descriptions thereof are omitted herein.

With the above decryption device 200, a safe network reception of the user data is achieved without the need of manually configuring and installing software on the information device.

Moreover, FIG. 2 is merely an example and can not construct any limitation and the decryption device 200 may also be implemented in other configuration.

For example, in another embodiment of the disclosure, the judging part may also inform the sending part to send the data package without decryption to information device, in the case that the judging part determines that the decryption does not need to be performed.

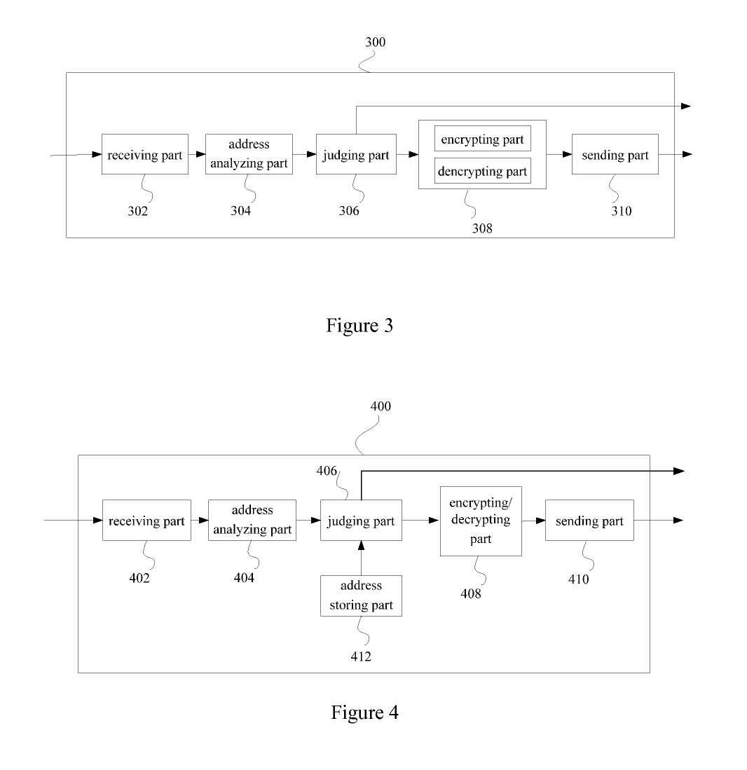

FIG. 3 is a schematic diagram illustrating an encryption/decryption device according to an embodiment of the disclosure. As an example, the encryption/decryption device may be a combination of the encryption and the decryption device as stated above.

As shown in FIG. 3, an encryption/decryption device 300 according to an embodiment of the disclosure may include a receiving part 302, an address analyzing part 304, a judging part 306, an encrypting/decrypting part 308 and a sending part 310.

The receiving part 302 may be adapted to receive a data package from a network or an information device in a wired or wireless manner.

The address analyzing part 304 may be adapted to analyze a source address or destination address of the data package received by the receiving part 302.

As an example, when the receiving part 302 receives the data package from the network, the address analyzing part 304 may be adapted to resolve the data package and obtain a source address of the data package.

As another example, when the receiving part 302 receives the data package from the information device, the address analyzing part 304 may be adapted to resolve the data package and obtain a destination address of the data package.

The judging part 206 may be adapted to judge whether an encryption process or a decryption process needs to be performed to the data package.

As an example, when the receiving part 302 receives the data package from the information device, the judging part 306 may judge whether an encryption process needs to be performed to the data package.

As another example, when the receiving part 302 receives the data package from the network, the judging part 306 may judge whether a decryption process needs to be performed to the data package.

In the case that the judging part 306 determines that the encryption or decryption process needs to be performed, the judging part 306 may transfer the data package to an encrypting/decrypting part 308.

The encrypting/decrypting part 308 in the encryption/decryption device 300 may include an encrypting part and a decrypting part.

The encrypting part may employ any suitable encryption technology to implement the encryption of the data package when the judging part 306 determines that the encryption process needs to be performed and the decrypting part may employ any suitable decryption technology to implement the decryption of the data package when the judging part 306 determines that the decryption process needs to be performed.

The sending part 310 may send the decrypted data package to the information device in a wired or wireless manner or send the encrypted data package to the network in a wired or wireless manner.

Moreover, the detail structure and configuration of the receiving part 302, the address analyzing part 304, the judging part 306, the encrypting/decrypting part 308 and the sending part 310 may be similar to the receiving part 102, 202, the address analyzing part 104, 204, the judging part 106, 206, the encrypting part 208, the decrypting part 308 and the sending part 110, 210 as stated above. Thus, detailed descriptions thereof are omitted herein.

With the above encryption/decryption device 300, a safe network transmission and reception of the user data is achieved without the need of manually installing and configuring software on the information device.

Moreover, FIG. 3 is merely an example and can not construct any limitation and the encryption/decryption device 300 may also be implemented in other configuration.

For example, in another embodiment of the disclosure, the judging part may also inform the sending part to send the data package without decryption to information device or inform the sending part to send the data package without encryption to network, in the case that the judging part determines that the decryption or encryption process does not need to be performed.

Furthermore, the relationship between the encryption/decryption device 300 and the information device may be similar to that between the encryption device 100 or the decryption device 200 and the information device and thus detailed descriptions thereof are omitted herein.

With reference to any of the encryption, the decryption device and encryption/decryption device as described above, the judging part may employ various measures to implement the judgment. The following descriptions are provided with the encryption/decryption device as shown in FIG. 3 as an example. Those skilled in the art can appreciate that the same judging method may also be applied in the encryption and the decryption device in a similar manner.

In an embodiment of the disclosure, whether the encryption/decryption process needs to be performed may be judged in accordance with the source address or the destination address of the data package and addresses which are stored in advance.

FIG. 4 illustrates an encryption/decryption device 400 according to the embodiment of the disclosure.

As shown in FIG. 4, the encryption/decryption device 400 may include a receiving part 402, an address analyzing part 404, a judging part 406, an encrypting/decrypting part 408, a sending part 410 and an address storing part 412.

Additionally, the receiving part 402, the address analyzing part 404, the encrypting/decrypting part 408 and the sending part 410 are similar to the receiving part 302, the address analyzing part 304, the encrypting/decrypting part 308 and the sending part 310 as stated above, and repeated descriptions thereof are omitted herein.

As shown in FIG. 4, in this embodiment, the judging part 406 may be adapted to judge whether the encryption process or the decryption process needs to be performed in accordance with the destination address or the source address of the data package and addresses stored in the address storing part 412.

As an example, the address storing part 412 may store in advance addresses requiring a higher level of security, such as an address relating to finance or an address relating to privacy. If the source address or the destination address of the data package obtained from the address analyzing part 404 is one of the addresses requiring a higher level of security stored in the address storing part 412, the judging part 406 may determine that the encryption or decryption process needs to be performed to the data package; otherwise, the judging part 206 may determine that the encryption and decryption process does not need to be performed to the data package.

By using the encryption/decryption device 400 which includes the address storing part 412, a quick and accurate judgment may be implemented.

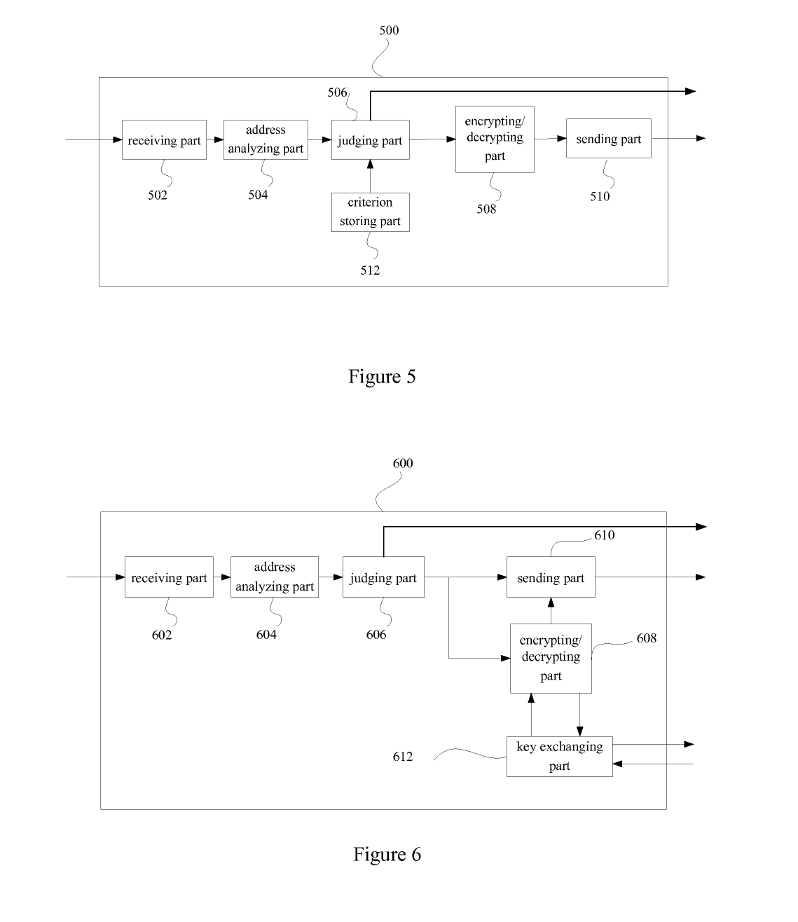

Alternatively, whether the encryption or decryption process needs to be performed may also be judged in accordance with the source address or the destination address of the data package and a criterion. Accordingly, FIG. 5 illustrates an encryption/decryption device 500 according to another embodiment of the disclosure.

As shown in FIG. 5, the encryption/decryption device 500 may include a receiving part 502, an address analyzing part 504, a judging part 506, an encrypting/decrypting part 508, a sending part 510 and a criterion storing part 512.

The receiving part 502, the address analyzing part 504, the encrypting/decrypting part 508 and the sending part 510 are similar to the receiving part 302, the address analyzing part 304, the encrypting/decrypting part 308 and the sending part 310 as stated above, and repeated descriptions thereof are omitted herein.

As shown in FIG. 5, in this embodiment, the judging part 506 may be adapted to judge whether the encryption or decryption process needs to be performed in accordance with the source address or the destination address of the data package and predetermined criterion stored in the criterion storing part 512.

As an example, the criterion storing part 512 may pre-store a criterion for judging whether the encryption or decryption process is required.

For example, information relating to certain addresses requires a higher level of security during the working time. Thus, the criterion may be as follows: for a data package of a source address or a destination address, the encryption/decryption process is needed during a particular time period such as from 9:00 to 17:00 every working day.

In this way, the judging part 506 may judge whether the encryption or decryption process needs to be performed to a data package according to a destination address or a source address of the data package obtained from the address analyzing part 504 and the criterion stored in the criterion storing part.

By using the encryption/decryption device 500 including the criterion storing part 312, the efficiency for implementing the judgment may be improved.

In another embodiment of the disclosure, a configuring part may be further included.

The following descriptions will be provided with the encryption/decryption device (such as the encryption/decryption devices 300, 400 and 500, referred as the encryption/decryption device for short hereinafter) as an example and those skilled in the art can appreciate that the configuring part may also be applied in the encryption and the decryption device in a similar manner.

The configuring part may be adapted to make a configuration to the encryption/decryption device.

For example, the configuring part may be adapted to configure the encryption/decryption algorithm and key for the encrypting/decrypting part, or configure the address for which the encryption/decryption process needs to be performed in the address storing part, or configure the criterion in the criterion storing part or configure one or more parts of the encryption/decryption device in combination.

The configuring part may be provided in the encryption/decryption device, or in the information device or outside the encryption/decryption device and the information device.

As an example, when the configuring part is provided in the encryption/decryption device, the configuring part may be any suitable input device such as keypad and touch-panel.

As another example, the configuring part is in communication with the information device, and the configuration may be implemented with a browser in the information device.

As another example, when the configuring part is provided outside the encryption/decryption device and the information device, the configuring part may be a remote control device.

By using the above encryption/decryption device including the configuring part, a safe network transmission of the user data is achieved without the need of installing and configuring software on the information device manually.

In another embodiment of the disclosure, in order to achieve a higher level of security, a key exchanging part may be further included. The following descriptions will be provided with the encryption/decryption device as an example and those skilled in the art can appreciate that the key exchanging part may also be applied in the encryption and the decryption device in a similar manner.

The key exchanging part may be adapted to update and exchange the key periodically so as to improve the security level. Accordingly, FIG. 6 illustrates an encryption/decryption device 600 according to another embodiment of the disclosure.

As shown in FIG. 6, the encryption/decryption device 600 may include a receiving part 602, an address analyzing part 604, a judging part 606, an encrypting/decrypting part 608, a sending part 610 and a key exchanging part 612.

The receiving part 602, the address analyzing part 604, the judging part 606 and the sending part 610 are similar to the receiving part 302, the address analyzing part 304, the judging part 306 and the sending part 310 as stated above, and repeated descriptions thereof are omitted herein.

As shown in FIG. 6, in this embodiment, the key exchanging part 612 may employ any suitable technology to update the key of the encrypting/decrypting part 608 and exchange the updated key among a plurality of encryption/decryption devices. The key exchanging part 612 may use Diffie-Hellman key exchanging method to implement the key update and exchange.

By using the above encryption/decryption device 600, a higher level of security may be achieved.

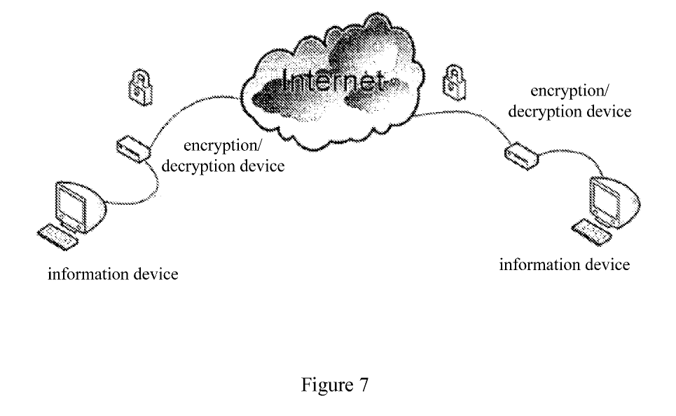

FIG. 7 is a schematic diagram illustrating a communication system according to an embodiment of the disclosure.

As shown in FIG. 7, a plurality of information devices are interconnected via the Internet and an encryption/decryption device is connected between each information device and the Internet.

Particularly, the encryption/decryption device may be an encryption/decryption device according to any of the above embodiments of the disclosure.

Hence, in the communication system as shown in FIG. 7, a safe network transmission of the user data is achieved without the need of installing and configuring software on information device manually. Thus, the user is easy to realize the security of data transmission.

In FIG. 7, the information device is indicated as a computer, the network is indicated as the Internet and an encryption/decryption device is located between each computer and the network. However, FIG. 7 is only an example and can not construct a limitation to the present disclosure. In another embodiment of the disclosure, the information device may be other device such as cell phone and media player. In another embodiment of the disclosure, the network may be other data-transmission network such as mobile telephone network, LAN and MAN. In another embodiment of the disclosure, the encryption/decryption device may be replaced with the encryption device or the decryption device. In another embodiment of the disclosure, the encryption/decryption device may mounted in the information device and the information device may directly send or receive data package in the case the no encryption or decryption process is required.

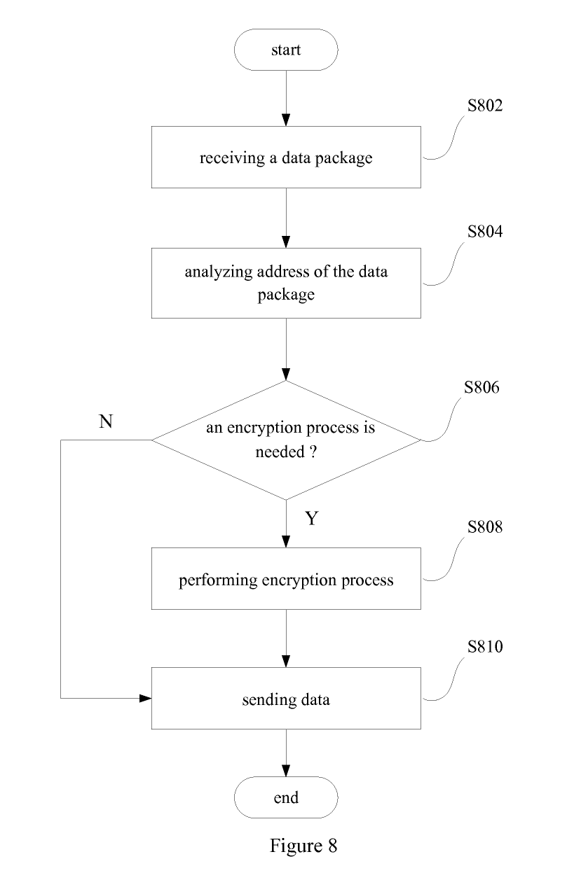

Embodiments of the present disclosure also provide an encryption method. FIG. 8 is a schematic diagram illustrating an encryption method according to an embodiment of the disclosure.

As shown in FIG. 8, the encryption method may include the following steps S802 to S810.

In step S802, a data package to be sent to a network is received from an information device.

The data package may be received from an information device in a wired or wireless manner.

The network may be any suitable data-transmission network such as Local Area Network (LAN), Metropolitan Area Network (MAN), mobile telephone network and the Internet.

The information device may be any suitable device which is adapted to receive and send data such as computer, cell phone and media player.

The data package may be various kind of data package such as content data package, multi-media data package, stream media data package and Internet Protocol (IP) data package.

Referring to FIG. 8, in step S804, a destination address of the data package is analyzed.

As an example, the data package may be resolved and a destination address of the data package may be obtained.

Moreover, the address obtained in step S804 may take any suitable form.

As an example, when the data package is the IP data package, the address obtained in step S804 may be the IP address of the data package.

As another example, when the data package is multi-media data package or stream media data package, the address may be the name of a sever storing the multi-media data package or stream media data package.

Referring to FIG. 8, in step S806, whether an encryption process needs to be performed to the data package is judged.

In the case that it is determined that the encryption process needs to be performed, the processing flow proceeds to step S808.

In step S808, an encryption process is performed and then, the process flow proceeds to step S810.

In the case that it is determined that the encryption process does not need to be performed, the processing flow proceeds to step S810.

In step S810, the data package is sent to the network.

As an example, the above steps S802-S810 may be implemented by the receiving part, the address analyzing part, the judging part, the encrypting part and sending part according to any one of the above embodiments of the disclosure.

With the above method, a safe network transmission of the user data is achieved without the need of installing and configuring software on the information device manually.

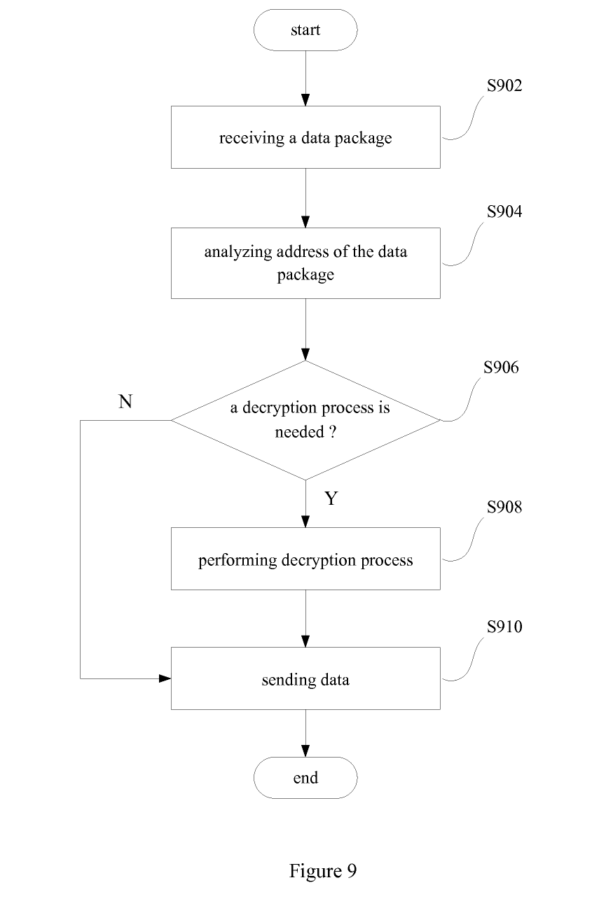

Embodiments of the present disclosure also provide a decryption method. FIG. 9 is a schematic diagram illustrating a decryption method according to an embodiment of the disclosure.

As shown in FIG. 9, the decryption method may include the following steps S902 to S910.

In step S902, a data package sent from an information device is received via a network.

The data package may be received in a wired or wireless manner.

Referring to FIG. 9, in step S904, a source address of the data package is analyzed.

As an example, the data package may be resolved and a source address of the data package may be obtained.

Referring to FIG. 9, in step S906, whether a decryption process needs to be performed to the data package is judged.

In the case that it is determined that the decryption process needs to be performed, the processing flow proceeds to step S908.

In step S908, a decryption process is performed and then, the process flow proceeds to step S910.

In the case that it is determined that the decryption process does not need to be performed, the processing flow proceeds to step S910.

In step S910, the data package is sent to the information device.

The above steps S902-S910 may be implemented by the receiving part, the address analyzing part, the judging part, the decrypting part and sending part according to any one of the above embodiments of the disclosure.

Moreover, the implementation details of steps 902-910 may be similar to those of steps 802-810 and repeated descriptions are omitted herein.

With the above method, a safe network reception of the user data is achieved without the need of installing and configuring software on the information device manually.

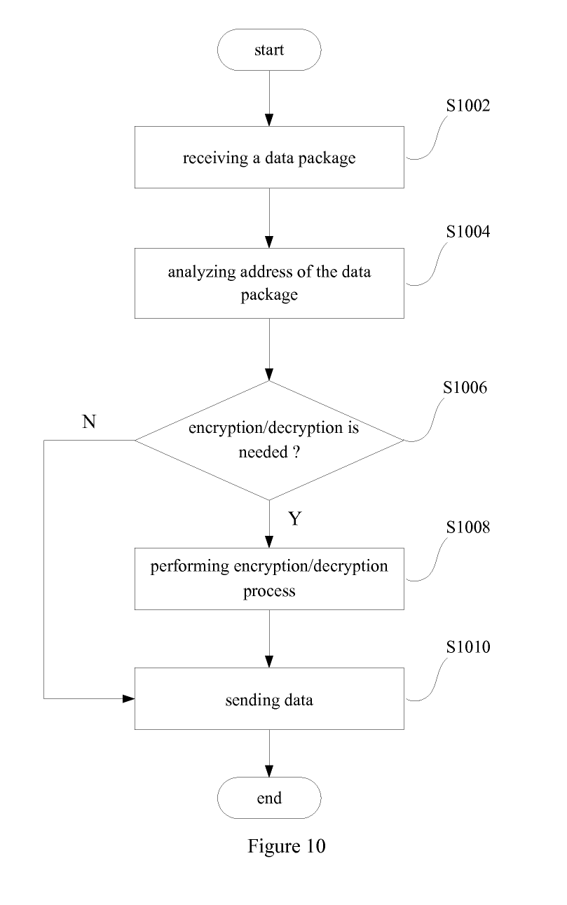

Embodiments of the present disclosure also provide an encryption/decryption method. FIG. 10 is a schematic diagram illustrating the method according to an embodiment of the disclosure.

As shown in FIG. 10, the encryption/decryption method may include the following steps S1002 to S1010.

In step S1002, a data package is received in a wired or wireless manner.

As an example, a data package to be sent to a network may be received from an information device.

As another example, a data package sent from an information device may be received via a network.

Referring to FIG. 10, in step S1004, a source address or a destination address of the data package is obtained.

As an example, when the data package sent from an information device is received via a network, the data package may be resolved and a source address of the data package may be obtained.

As another example, when the data package to be sent to a network is received from an information device, the data package may be resolved and a destination address of the data package may be obtained.

Referring to FIG. 10, in step S1006, whether an encryption or decryption process needs to be performed to the data package is judged.

In the case that it is determined that the encryption or decryption process needs to be performed, the processing flow proceeds to step S1008.

In step S1008, the encryption or decryption process is performed and then, the process flow proceeds to step S1010.

In the case that it is determined that the encryption or decryption process does not need to be performed, the processing flow proceeds to step S1010.

In step S1010, the encrypted data package is sent to the network or decrypted data package is sent to the information device.

The above steps S1002-S1010 may be implemented by the receiving part, the address analyzing part, the judging part, the encrypting part or the decrypting part and sending part according to any one of the above embodiments of the disclosure.

Moreover, the implementation details of steps 1002-1010 may be similar to those of steps 802-810 and steps 902-910 and repeated descriptions are omitted herein.

With the above method, a safe network transmission and reception of the user data is achieved without the need of installing and configuring software on information device manually.

As for any of the above methods, various methods may be employed to implement the judgment. The following descriptions are provided with the encryption/decryption method as an example, however, those skilled in the art can appreciate that the method for implementing judgment may also be applied in above encryption method or decryption method.

In an embodiment of the disclosure, whether the encryption/decryption process needs to be performed may be judged in accordance with the source address or the destination address of the data package and addresses which are stored in advance.

As an example, addresses requiring a higher level of security, such as address relating to finance and address relating to privacy may be stored in advance. If the source address or the destination address of the data package is one of the addresses requiring a higher level of security, it is determined that the encryption or decryption process needs to be performed to the data package, otherwise, it is determined that the encryption or decryption process does not need to be performed to the data package.

In this embodiment, by using the addresses which are stored in advance, a quick and accurate judgment may be implemented.

Alternatively, in another embodiment of the disclosure, whether the encryption or decryption process needs to be performed may also be judged in accordance with the source address or the destination address of the data package and a criterion.

As an example, a criterion for judging whether the encryption or decryption process is required may be pre-stored. For example, the criterion may be as follows: for a data package relating to an address, the encryption or decryption process is needed during a particular time period such as from 9:00 to 17:00 every working day. In this way, the judgment may be implemented according to a source address or a destination address of the data package and the criterion stored in the criterion storing part.

In this embodiment, by using the criterion, the efficiency for implementing the judgment may be improved.

As for any of the above methods, a configuration step may be further included.

In an embodiment of the disclosure, in the configuration step, the encryption or decryption algorithm and key may be configured, or the address which requires the encryption or decryption process may be configured, or the criterion may be configured, or one or more of the above contents may be configured in combination.

As an example, the configuration step may be implemented by a touch panel or by a browser in the information device.

As another example, the configuration step may be implemented by a remote control device.

Additionally, the configuration step may be performed at any time during performing the method. For example, the configuration step may be performed before, after or simultaneously with the step for receiving a data package or the step for analyzing address.

By using the above encryption/decryption method including the configuring step, a safe network transmission of the user data is achieved without the need of installing and configuring software on information device manually.

Additionally, in order to achieve a higher level of security, the key for the encryption or decryption may be updated.

In an embodiment of the disclosure, the encryption/decryption method may further include a key exchanging step. In the key exchanging step, the key may be updated and exchanged periodically so as to improve the security level.

For example, the Diffie-Hellman key exchanging method may be used to implement the key update and exchange.

By using the above encryption/decryption method including the key exchanging step, a higher level of security may be achieved.

In addition, the encryption/decryption method according to the embodiments of the disclosure may be implemented by a program product or a set of program instructions that can be operated on any information processing device. The information processing device may be any appropriate processing device, such as a computer, a hand-held device, or an embedded device or the like. Therefore, such program product or program instructions, as well as machine-readable medium storing the program product or program instructions thereon, also constitute part of the disclosure. The machine-readable medium may include any existing and future storage medium.

Furthermore, the parts in the above described device according to the embodiments of the disclosure, such as the receiving part, the address analyzing part, the judging part, the sending part, the encrypting/decrypting part, the address storing part, the criterion storing part and the configuring part, may be realized as software components that can be operated on a chip, or may be realized by a specialized circuit, e.g. a single chip or the like. Therefore, such software components and/or circuits (e.g. chips) also constitute part of the disclosure.

It can be understood by a person of ordinary skill in the art that there is little distinction left between hardware and software implementations of the aspects of the device described above; the use of hardware or software is generally (but not always, in that in certain contexts the choice between hardware and software can become significant) a design choice representing cost vs. efficiency tradeoffs.

The foregoing detailed description has set forth various embodiments of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” or “comprising” should be interpreted as “including but not limited to,” the term “having” should be interpreted as “having at least,” the term “includes” or “comprises” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to disclosures containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An encryption/decryption device, comprising:
a receiving part, adapted to receive a data package from an information device or a network;
an address analyzing part, adapted to analyze a source address and[[/or]] a destination address of the data package;
a judging part, adapted to judge whether an encryption/decryption process needs to be performed in accordance with the source address and the destination address of the data package;
an encrypting/decrypting part, adapted to encrypt/decrypt the data package in the case that the encryption/decryption process is required; and
a sending part, adapted to send an encrypted or decrypted data package to the information device or the network in the case that the encryption/decryption process is required, the sending part also being adapted to send the data package without encryption/decryption in the case that the judging part judges that the encryption/decryption process does not need to be performed.

2. The device according to claim 1, wherein the device is provided outside the information device, and the receiving part and the sending part are coupled to the information device in a wired or wireless manner.

3. The device according to claim 1, wherein the device is mounted in the information device via a slot.

4. The device according to claim 1, wherein the device is realized integrally in the information device in a manner of software and/or hardware.

5. The device according to claim 1, wherein the information device comprises a computer.

6. The device according to claim 1, wherein the data package comprises an IP data package.

7. The device according to claim 1, further comprising an address storing part, adapted to store an address for which the encryption/decryption process needs to be performed;
wherein the judging part is adapted to judge whether the encryption/decryption process needs to be performed in accordance with the source address and/or the destination address of the data package and the address stored in the address storing part.

8. The device according to claim 1, further comprising a criterion storing part, adapted to store a criterion for judging whether the encryption/decryption process needs to be performed;
wherein the judging part is adapted to judge whether the encryption/decryption process needs to be performed in accordance with the source address and/or the destination address of the data package and the criterion stored in the criterion storing part.

9. The device according to claim 1, further comprising a configuring part adapted to configure an encryption/decryption algorithm and a key for the encryption/decryption process, and/or, an address for which the encryption/decryption process needs to be performed, and/or a content to which the encryption/decryption process needs to be performed, and/or the criterion.

10. The device according to claim 9, wherein the configuring part further comprises a touch-panel.

11. The device according to claim 9, wherein the configuring part is in communication with the information device and a configuration is made via a browser in the information device.

12. The device according to claims 1, further comprising: a key exchanging part, adapted to exchange the key via a Diffie-Hellman key exchanging method.

13. An encryption/decryption method, comprising:
receiving a data package from an information device or a network;
analyzing a source address and a destination address of the data package;
judging whether an encryption/decryption process needs to be performed in accordance with the source address and the destination address of the data package;
encrypting/decrypting the data package in the case that it is determined that the encryption/decryption process needs to be performed; and
sending the data package without encryption/decryption in the case that the encryption/decryption process is not necessary.

14. The method according to claim 13, wherein the information device comprises a computer.

15. The method according to claim 13, wherein the data package comprises an IP data package.

16. The method according to claim 13, wherein judging whether the encryption/decryption process needs to be performed in accordance with the source address and the destination address of the data package comprises: judging whether the encryption/decryption process needs to be performed in accordance with the source address and the destination address of the data package and an address stored in advance for which the encryption/decryption process is necessary.

17. The method according to claim 13, wherein judging whether the encryption/decryption process needs to be performed in accordance with the source address and the destination address of the data package comprises: judging whether the encryption/decryption process needs to be performed in accordance with the source address and the destination address of the data package and a criterion configured in advance.

18. The method according to claim 13, further comprising: configuring an encryption/decryption algorithm and a key for the encryption/decryption process, and/or, an address for which the encryption/decryption process needs to be performed, and/or a content which needs the encryption/decryption process, and/or the criterion via a touch-panel or a browser.

19. The method according to claim 13, further comprising: exchanging the key via a Diffie-Hellman key exchanging method.

20. A communication system, comprising:
at least one information device; and
at least one encryption/decryption device, connected with the at least one information device respectively;
wherein the encryption/decryption device comprises:
a receiving part, adapted to receive a data package from an information device or a network;
an address analyzing part, adapted to analyze a source address and a destination address of the data package;
a judging part, adapted to judge whether an encryption/decryption process needs to be performed in accordance with the source address and the destination address of the data package;
an encrypting/decrypting part, adapted to encrypt/decrypt the data package in the case that the encryption/decryption process is required; and
a sending part, adapted to send an encrypted or decrypted data package to the information device or the network in the case that the encryption/decryption process is required, the sending part also being adapted to send the data package without encryption/decryption in the case that the judging part judges that the encryption/decryption process does not need to be performed.

21. (canceled)

22. A storage medium, comprising a machine executable program code, wherein the machine executable program code is executable in an information processing device to perform operations comprising:
receiving a data package from an information device or a network;
analyzing a source address and a destination address of the data package;
judging whether an encryption/decryption process needs to be performed in accordance with the source address and the destination address of the data package;
encrypting/decrypting the data package in the case that it is determined that the encryption/decryption process needs to be performed; and
sending the data package without encryption/decryption in the case that the encryption/decryption process is not necessary.
